(19) United States
(12) Patent Application Publication
(10) Pub. No.: US 2017/0102122 A1
(43) Pub. Date: Apr. 13, 2017

(54) LAMP ARRANGEMENT

(71) Applicant: JOSEPH ONESTO, Thousand Oaks, CA (US)

(72) Inventor: JOSEPH ONESTO, Thousand Oaks, CA (US)

(21) Appl. No.: 14/756,780

(22) Filed: Oct. 13, 2015

(51) Int. Cl. F21V 3/02; F21S 8/00; F21V 17/14; F21V 23/00

(52) U.S. Cl. CPC F21V 3/02; F21V 23/001; F21S 8/03; F21V 17/14; F21W 2121/00

(57) ABSTRACT

A novelty lamp arrangement in which there is provided a light transmitting body member with a light emitting de ice therein and wherein the body member is the form of a hog's head or sow's head and the emitted light appears to be emanating from the body member.

### BACKGROUND OF THE INVENTION

Field of the Invention

This invention relates to the illumination art and more particularly to a unique electrically powered lamp arrangement for emitting light.

Description of the Prior Art

Since the discovery of controllable electricity, many variations of devices and arrangements for providing illuminating light have been made and used. Such uses include table lamps, ceiling fixtures, night lights and other light emitting devices devices primarily designed for comparatively stationary utilization, as well as flash lights, vehicle lights and the like, utilized for mobile applications. Many of these lights are highly artistic and ornamental as well as utilitarian.

However, there has not been any light emitting lamps which are ornamental and decorative and may be utilized as both stationary light sources on, for example, a table or desk top as a night light or the like as well as on vehicles to provide indications of the presence of the vehicle.

Accordingly, it is an object of the present invention to provide an ornamental and decorative electrically powered light emitting arrangement.

It is another object of the present invention to provide an ornamental and decorative electrically powered light emitting arrangement which may be utilized for both stationary applications and on vehicles for mobile application.

It is another object of the present invention to provide an ornamental and decorative electrically powered light emitting arrangement which may be utilized for both stationary applications and on vehicles for mobile application and which incorporates a replication of an animal or human face including the replication of eyes.

It is yet another object of the present invention to provide an ornamental and decorative electrically powered light emitting arrangement which may be utilized for both stationary applications and on vehicles for mobile application and which incorporates a replication of an animal or human face including the replication of eyes and in which light appears to be emitted from the eyes.

The above and other objects of the present invention are achieved in the various preferred embodiments described herein. In a first preferred embodiment there is provided a body member having a preselected geometrical configuration. The configuration may be, for example, the rep presentation of a human or animal. The body member is preferably fabricated from a translucent or transparent material and, in this preferred embodiment, the body member incorporates at least the face of the human or animal defined by the body member. The body member has an external surface defining an interior portion. The body member may be solid or hollow, depending upon the desired application. In those embodiments of the present invention wherein the body member is hollow, the body member includes a shell enclosing the interior portion. In the preferred embodiment of the present invention the body member which includes a representation of a face, the face incorporates a representation of eyes. The body member may also include a substantially planar base portion upon which the body member may rest on any desired preselected surface.

A threaded aperture is provided in the body member and a preselected location at the external surface and extending inwardly into the interior portion. In those embodiments of the present invention in which the body member has a hollow interior portion, a boss may be provided extending in the interior portion at the preselected location where the threaded aperture is located so as to provide a sufficient thickness for threading.

A tubular nipple with a threaded external surface is provided and threadingly engages the threaded aperture of the body and extends inwardly into the interior of the body member a preselected distance and terminates at an interior and thereof the tubular nipple has inside walls defining a passageway extending through the tubular nipple into a preselected position within the interior of the body member.

An electrically powered light emitting member or device such as, for example, an LED or grain of sand bulb or the like is positioned in the interior of the body member and they, for example, the positioned at the end of the tubular nipple and the wires for transmitting electrical energy to the light-emitting member extend through the tubular member to regions external the body member for suitable connection to switches and a source of electrical energy such as a battery.

Is utilized herein the word “light” refers to electromagnetic radiation in the visible portion of the spectrum which is detectable by humans and “translucent” and “transparent” and refer to the physical characteristics of transmitting such “light”.

In those preferred embodiments of the present invention wherein the body member incorporates a representation of a face and the face incorporates representation of eyes, the light emitting device or member may be placed adjacent each of the eyes incorporated in the body member to give the appearance of light shining therethrough. In some other preferred embodiments of the present invention the body member may provide the representation of a pig's face, either a boar or a sow, and the light emitting member may be redirected to be adjacent to the representation of the eyes to give the appearance of the light shining therethrough. In yet other preferred embodiments of the present invention the like may be positioned in the interior of the body member to provide the emission of light throughout substantial portions of the body member in a preselected pattern.

The threaded aperture in the body member may be positioned at any portion of the external surface as may be desired for particular applications, to provide access to the interior portion of the body member for positioning the light emitting member at any location therein.

### BRIEF DESCRIPTION OF THE DRAWING

The above and other embodiments of the present invention my be more fully understood from the following detailed description taken together with the accompanying drawing wherein similar reference characters refer to similar elements throughout and in which:

FIG. 1 illustrates a first embodiment of the present invention wherein the lamp arrangement incorporates a replication of a hogs head;

FIG. 2 illustrates another embodiment of the present invention wherein the lamp arrangement incorporates a replication of a hogs head;

FIG. 3 illustrates another embodiment of the present invention wherein the lamp arrangement incorporates a replication of a sow's head;

FIG. 4 illustrates an exploded view of the embodiment of the present invention shown in FIG. 1;

FIG. 5 illustrates another exploded view of the embodiment of the present invention shown in FIG. 1;

FIG. 6 illustrates an exploded view of another embodiment of the present invention wherein the lamp arrangement incorporates a replication of a hog's head;

FIG. 7 illustrates another embodiment of the present invention wherein the lamp arrangement incorporates a replication of a hog's head;

FIG. 8 illustrates another embodiment of the present invention wherein the lamp arrangement incorporates a replication of a hog's head;

FIG. 9 illustrates a front view of the embodiment of the present invention shown in FIG. 1; and,

FIG. 10 illustrates a front view of the embodiment of the present invention shown in FIG. 7.

### DESCRIPTION OF THE PREFERRED EMBODIMENTS

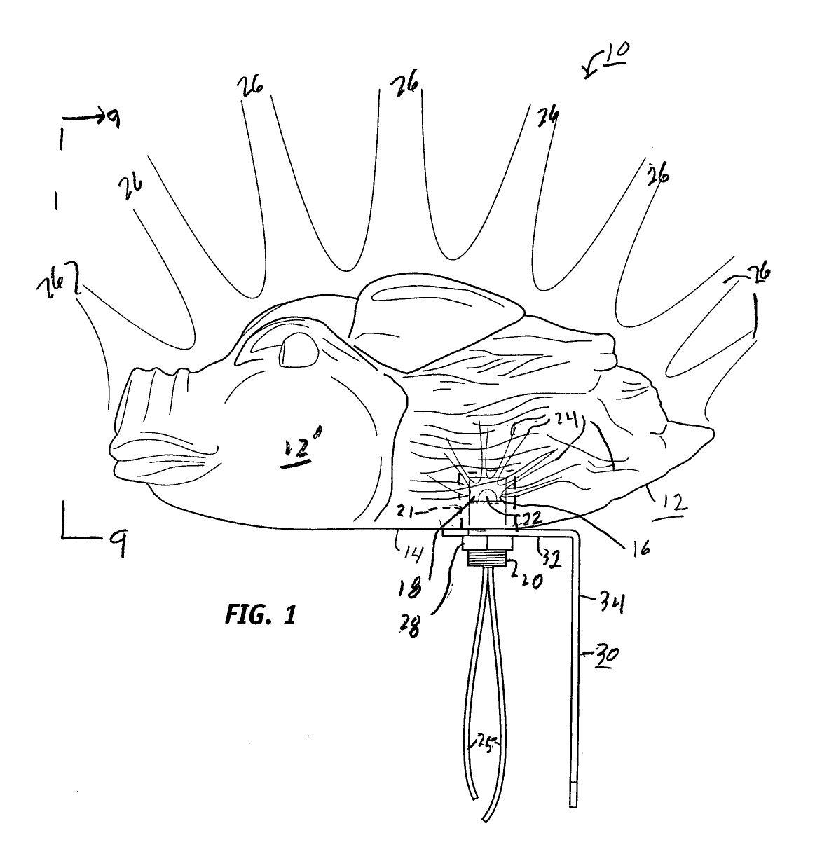

Referring now to the drawing there is illustrated in FIG. 1 a first embodiment of the present invention generally designated 10 of a lamp arrangement according to the principles of the present invention. The lamp arrangement of embodiment 10 incorporates a body member 12 which may be transparent, translucent or other material FIG. 3 illustrates another embodiment of the present invention wherein the lamp arrangement incorporates a replication of a sow's head;

### DESCRIPTION OF THE PREFERRED EMBODIMENTS

Which allows the transmission of electromagnetic radiation in the visible portion of the electromagnetic radiation spectrum therethrough. Thus, the body member 12 may be fabricated from materials such as **************. In the embodiment 10 the body member 12 incorporates a replication of a sow's head. The body member 12 has a generally planar surface 14 at the base thereof and the remainder of the external surface 12′ of the body member 12 is fabricated to define a replication of a sow's head as noted above. The body member 12 also has an interior surface indicated at 16 which surface 16 defines an internal aperture 18 in the body member 12. In this embodiment 10 of the present invention the internal surface 16 is threaded to accept a threaded, tubular nipple 24 inserted therein. In the embodiment 10 as shown on FIG. 1 the aperture 18 with the threaded walls 16 extends into the body member 12 a preselected distance from the planar base 14 .

A light emitting device 22 is mounted by conventional means in the tubular nipple 20 so that it projects into the aperture 18. Electrically conductive wires 24 are connected to the light-emitting device 22 and the electrically conductive wires 24 may be connected to any desired source of electrical energy (not shown). The light-emitting device may be a light emitting diode, grain of wheat bulb, a conventional filament bulb, a fluorescent bulb or the like and emits visually detectable light, generally indicated by the lines 24, into the interior of the body member 12 and the light 24 is transmitted through the body member 12 to provide a visually detectable light indicated at 26 from regions external the body member 12.

The tubular nipple 20 is retained in place by conventional nut 28. A mounting bracket 30 which in the embodiment 10 is in the form of an angle bracket, has one leg 32 thereof clamped between the nut and the planar base portion 14 of the body member 12. The other leg 34 may be utilized to connect the lamp arrangement of the embodiment 10 to any desired structure.

The body member 12 may be solid or may be a shell as long as it is capable of transmitting the visual light therethrough . The mounting bracket 30 may be utilized to mount the embodiment 10 point any desired structure such as, for example, the front fender or rear fender of a motorcycle, on the hood an automobile or truck as a hood ornament, or on any non-mobile source such as a wall of a house to provide a night light. In the embodiment 10 of FIG. 1, as well as the other embodiments of the present invention described below, wherein the body member 12 is a shell, a sufficiently large boss indicated at 21 surrounds the aperture 18 so as to enable the threading thereof for acceptance of the nipple 20. In the embodiment 10 the light 26 appears to be emanating from the entire body member 12.

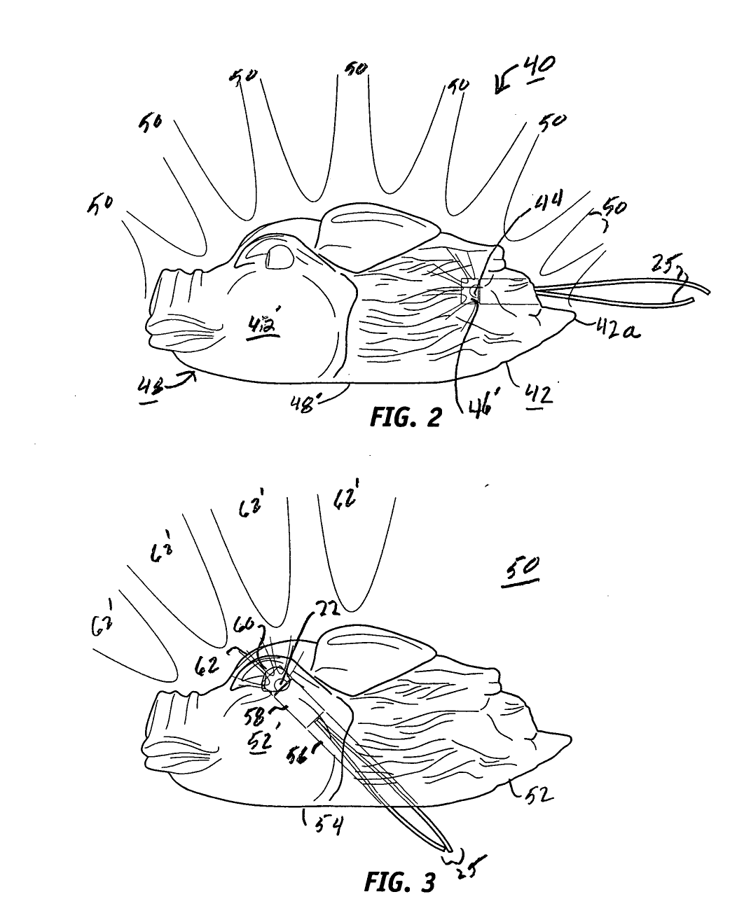

FIG. 2 of the drawing illustrates an embodiment 40 of the present invention which is generally similar to the embodiment 10 described above and has a body member 42 generally similar to the body member 12 described above in connection with FIG. 1 and the external surface 42′ thereof replicates a sow's head. The body member 42 may be either solid or a shell and fabricated from a material that transmits electromagnetic radiation in the visual portion of the electromagnetic radiation spectrum. In the embodiment 40, the light emitting device 44 is positioned in an aperture 46 extending from the back portion 42a rather than from the base 48 of the body member 42 as shown in FIG. 1. The generally planar base portion 48 of the body member 42 may be utilized for mounting the lamp arrangement of embodiment 40 on any desired surface. In the embodiment 40 the light emitted by the light-emitting device 44 as indicated at 50 appears to be emanating from all of the surface 42′ of the body member 42 just as in the embodiment 10 described above.

Referring now to FIG. 3 there is illustrated embodiment the of the present invention which is generally similar to the embodiments 10 and 40 described above. The embodiment 50 has a body member 52 with an external surface 52′ and a planar base portion 54. The body member 52 may be fabricated from any similar material such as that described above in connection with FIGS. 1 and 2 and is capable of transmitting electromagnetic radiation in the visible portion of the electromagnetic spectrum therethrough .the body member 52 may be solid or may be a shell . An aperture 56 is provided in the body member 52 so that the light-emitting device 22 contained within a nipple indicated at 58 in the aperture 56 is adjacent to the simulated eye 60 so that the light 62 emitted there from appears to be shining through BIA 62 .in the embodiment 50 the aperture 56 extends from the base 54 to the eye 60 and electrical wires 25 extend from the light-emitting device sent 22 through the nipple 58 and the aperture 56 to be connected to any desired source of electrical energy as viewed from outside of the external surface 52′,the light detectable from regions external the body member 52 appeared to be coming from the eye 60.

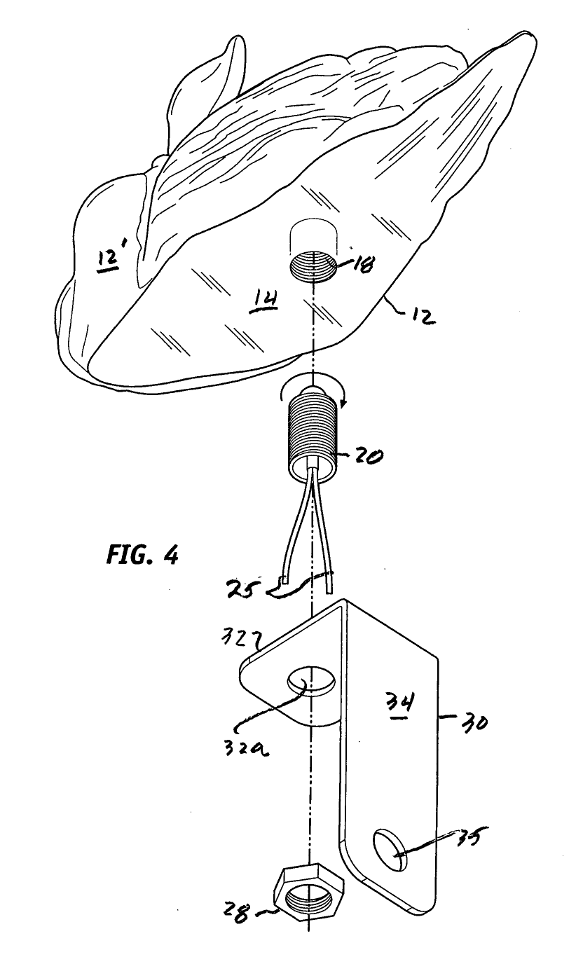

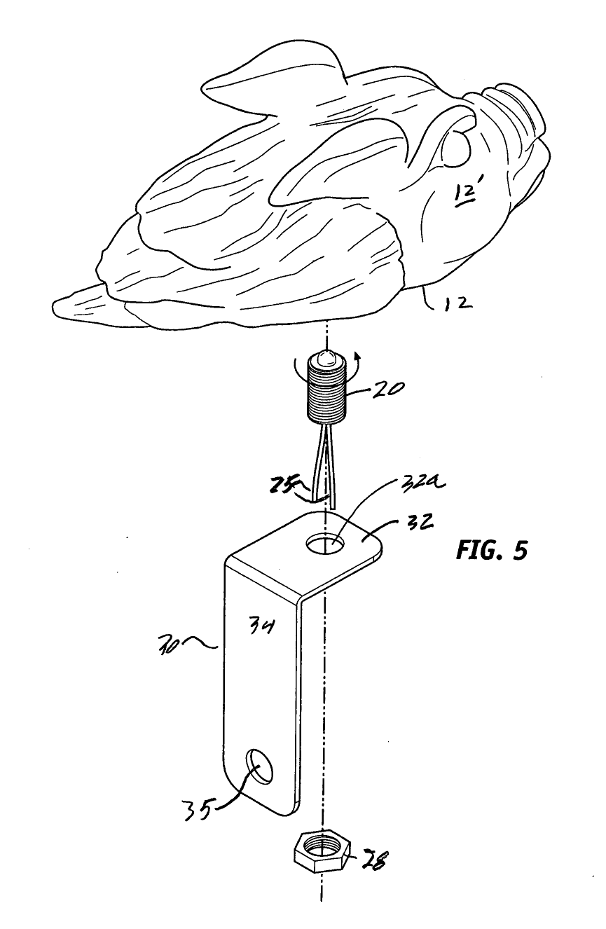

FIGS. 4 and 5 illustrate exploded views on the embodiment 10 described above showing the mounting of the mounting bracket 30 on the base 14 of the body member 12 with the nipple 20 extending through the aperture 32a in the leg 32 of the mounting bracket 30 and into the aperture 18 in the body member 12. As noted above the not 28 threadingly engages the nipple 20 to retain the mounting bracket 30 place. A mounting aperture 35 may be provided in the leg 34 of the mounting bracket 30 to facilitate the mounting of the lamp arrangement of embodiment 10 on any desired surface.

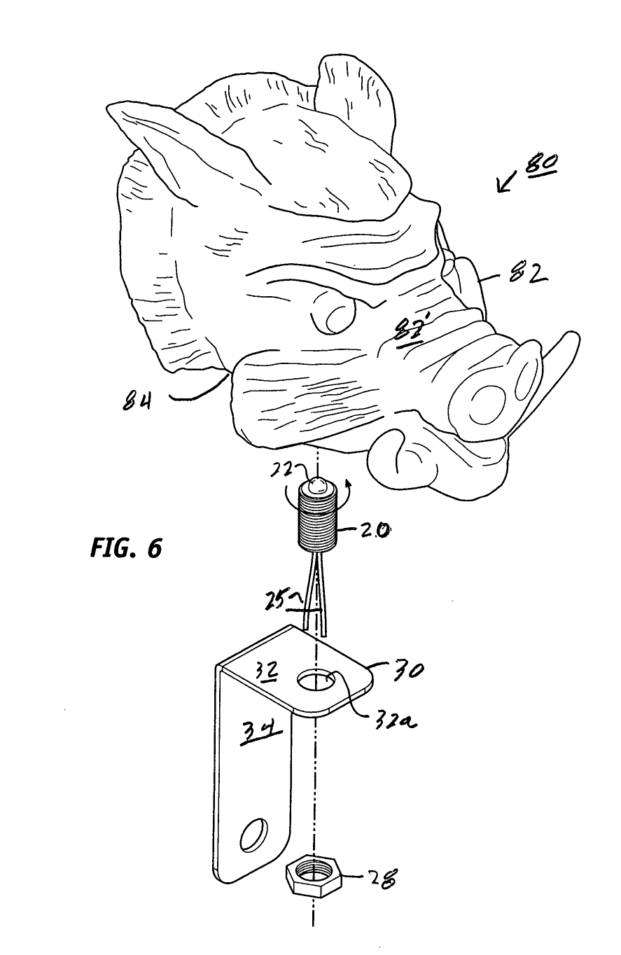

Referring now to FIG. 6 there is illustrated an exploded view of an embodiment 80 of the present invention generally similar to the embodiments 10 and 40 described above is illustrated in the exploded views of FIGS. 4 and 5. The embodiment 80 is provided with a body member 82 having an external surface 82′. In the embodiment 80 the external surface 82′ is configured to replicate a hog's head. The body member 82 may be fabricated from materials similar to that described above in connection with embodiments 10 and 40 above and which transmit visual light therethrough. A nipple 20 extends into an aperture paren not shown in FIGS. 6) extending from the base 84 of the body member 82 and the light-emitting device 22 is positioned in the nipple 20. The light-emitting device 22 radiates the late through the body member 82 so as to be visually detectable from regions external the body member 82.

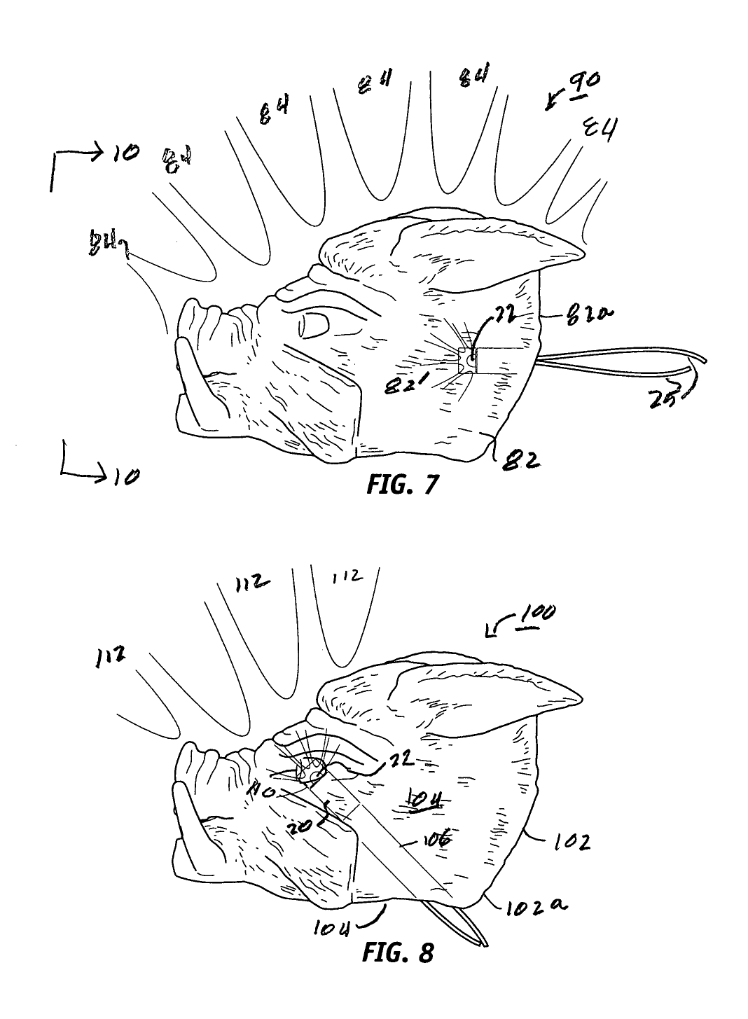

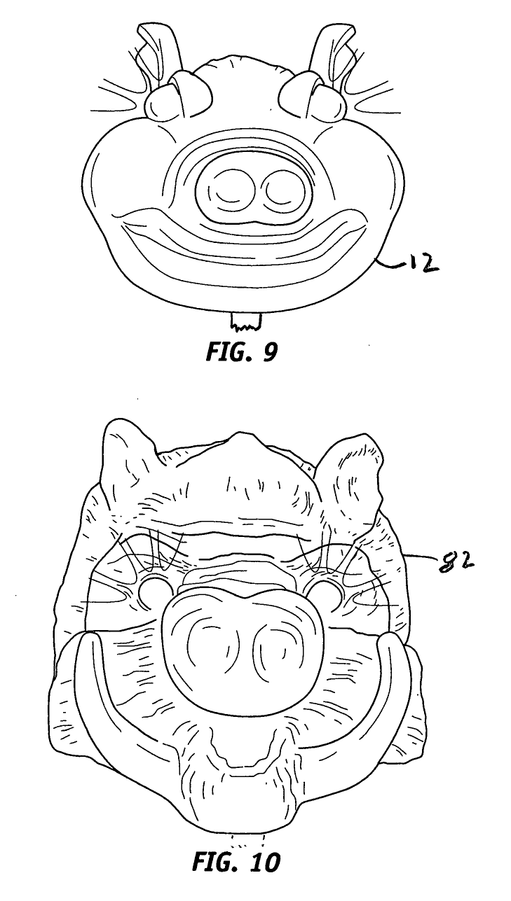

Referring now to FIG. 7, there is illustrated an embodiment of the present invention generally designated 90 which incorporates a body member 82 having an external surface 82 prime in the configuration of the replication of a hog's head such as that shown in the embodiment 80 described above .the embodiment 70 has a light source 22 extending into the body member 82 from regions adjacent the back 82 a thereof and the light emitted by the light-emitting device 22 as indicated at 84 appears to be emitted from of the entire external surface 82 prime of the body member 82 in the embodiment 90 is, therefore, similar to the embodiment 40 described above except that the body member is configured to replicate a hog's head.

FIG. 8 illustrates an embodiment 100 of the present invention in which there is a body member 102 having an external surface 104 and the external surface 104 is configured to replicate a hog's head such as that shown in the embodiments 80 and 90 described above . The embodiment 100 is similar to the embodiment 50 illustrated in FIG. 3 in that the light-emitting device 22 is positioned adjacent the simulated eye 110 so that the light 112 emitted from the body member 102 appears to be emanating from the eye 110.

Although specific embodiments of the present invention have been described above with reference to the various Figures of the drawing, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

1. A lamp arrangement comprising, in combination:
a body member having a preselected geometrical configuration, at least a portion of said body member comprised of a preselected material selected from the class consisting of translucent and transparent materials, and said preselected geometrical configuration having the representation of at least a face selected from the class consisting of animals and humans;
said body member having an external surface and a portion of said external surface comprising a substantially planar base portion, and an interior portion inside said external surface;
a threaded aperture in said body member extending into said body member at a preselected location on said external surface from said external surface of said body member a preselected distance into said interior portion of body member;
a tubular threaded nipple threadingly engaging said threaded aperture and having a first portion extending into said body member to an interior end thereof positioned at a predetermined location in said body member and said threaded nipple having walls defining a passageway extending therethrough to said interior end from regions external said body member;
an electrically powered light emitting member mounted in said interior portion of said body member end of said tubular threaded nipple and electricity transmitting wires connected to said light emitting device for transmitting electrical energy thereto, and said electricity transmitting wires extending through said tubular threaded nipple to regions external said body member.

2. The arrangement defined in claim 1 wherein:
said body member is solid and said solid body member transmits light therethrough.

3. The arrangement defined in claim 1 wherein:
said body member comprises a shell portion defining said interior portion and said interior portion defined by said shell portion is at hollow.

5. The arrangement defined in claim 1 and further comprising:
a mounting bracket operatively connected to said body member for supporting said body member for the condition of said body member on a preselected surface.

6. The arrangement defined in claim 1 wherein:
said face of said body member is the representation of a pig's face.

7. The arrangement defined in claim 6 wherein:
said pig is a boar.

8. The arrangement defined in claim 7 wherein:
said face of said boar comprises a representation of a pair of eyes and said electrically powered light emitting device is positioned to shine light through said representation of said eyes.

9. The arrangement defined in claim 8 wherein:
light from said electrically powered light emitting device is transmitted through said body member to be substantially transmitted only through said representation of said eyes.

10. The arrangement defined in claim 6 wherein:
said pig is a sow.

11. The arrangement defined in claim 10 wherein:
said face of said sow comprises a representation of a pair of eyes and said electrically powered light emitting device is positioned to shine light through said representation of said eyes.

12. The arrangement defined in claim 11 wherein:
light from said electrically powered light emitting device is transmitted through said body member to be substantially transmitted only through said representation of said eyes.

13. The arrangement defined in claim 1 wherein:
said electrically powered light emitting device comprises at least one LED.

14. The arrangement defined in claim 1 wherein:
said threaded aperture extends from said planar base portion of said body member.

15. The arrangement defined in claim 13 wherein:
said electrically powered light emitting device is in said interior portion of said body member and spaced from said external surface.

16. The arrangement defined in claim 1 wherein:
said body member is substantially solid and is translucent.

17. The arrangement defined in claim 3 wherein:
said shell portion of said body member is substantially translucent.
